(19) United States
(12) Patent Application Publication
(10) Pub. No.: US 2025/0185670 A1
(43) Pub. Date: Jun. 12, 2025

(54) NEMATICIDAL COMPOSITION FOR CONTROL OF PLANT PARASITIC NEMATODES

(71) Applicant: NEMATERRA BVBA, Westerlo (BE)

(72) Inventors: Christine Maria Frans VOS, Westerlo (BE); Vanessa DA SILVA MATTOS, Westerlo (BE); Ariadna GINÉ BLASCO, Westerlo (BE)

(73) Assignee: NEMATERRA BVBA, Westerlo (BE)

(21) Appl. No.: 18/845,299

(22) PCT Filed: Feb. 14, 2023
(86) PCT No.: PCT/EP2023/053656

§ 371 Date: Sep. 9, 2024

(30) Foreign Application Priority Data
Mar. 11, 2022 (BE) 2022/5168

(51) Int. Cl. A01N 63/50; A01N 65/44; A01P 5/00

(52) U.S. Cl. CPC A01N 63/50; A01N 65/44; A01P 5/00

(57) ABSTRACT

A nematicidal composition for control of plant parasitic nematodes comprised of an enzymatic plant protein hydrolysate. A method for parasitic nematode control in the soil of a plant by application of the nematicidal composition and its use for the control of parasitic nematodes in the soil of a plant.

The present invention relates to a nematicidal composition for control of plant parasitic nematodes comprised of plant protein hydrolysate. The present invention further relates to a method for parasitic nematode control in the soil of a plant by application of the nematicidal composition and its use for the control of parasitic nematodes in the soil of a plant.

Root-knot nematodes are worm like, soil borne, plant parasitic nematodes of microscopic size belonging to the genus Meloidogyne. They are obligate plant parasites of the roots of a wide host spectrum of economically important plant species with worldwide distribution including crops such as tomato, coffee beans, soybeans, cassava, beans, cereals, tobacco and fruit trees. The genus includes more than 50 species, of which several species are responsible for the majority of the pests worldwide; M. javanica, M. incognita, M. arenaria, M. hapla, M. chitwoodi, M. fallax, and M. naasi.

Root-knot nematode juveniles are active, thread-like worms about 0.5 mm long that penetrate the roots and cause considerable damage. Root-knot nematodes can cause typical galling or ‘root-knot’ swellings on the roots of the plant, and heavily galled roots may rot away, leaving a poor root system with a few large galls. This highly impacts the water and nutrient uptake of the plant, results in poor growth, and a decline in quality and yield of the crop. It can also reduce resistance to other stresses such as drought and disease, and may eventually lead to plant death and thus substantial crop and yield loss.

The life cycle of the root-knot nematodes begins as eggs that rapidly develop into J1 (first-stage juvenile) nematodes. The J1 stage resides entirely inside the egg case, where it molts into a J2 (second stage juvenile) nematode. Root-knot nematode J2 hatch from eggs and move through the soil and invade roots of plants near the root tip. The motile J2 is the only stage present in the soil that can infect the plant roots. Therefore, the J2 stage is an important target for current nematicide treatments. J2 root knot nematodes migrate in the soil searching for growing root tips, they enter roots intercellularly and become sedentary for the rest of their life, establishing a feeding site around them known as ‘giant cells’. Once the giant-cells are initiated, these nematodes undergo two more juvenile stages (J3 and J4) until the final stage as globose adult females or (rarely) vermiform adult males. The young females begin to feed and remain inside the roots for the rest of their life. As a result of nematode feeding, large galls or “knots” can form throughout the root system limiting the ability of the infected plant to absorb and transport water and nutrients.

Mature female nematodes then lay hundreds of eggs on the root surface, which hatch to continue the life cycle. Soil moisture conditions that are optimal for plant growth are also ideal for the development of root-knot nematodes. A single female can produce 500 to more than 1000 eggs. They lay their eggs into gelatinous masses that keep the eggs together which protects them against environmental extremes and predation. The egg masses are usually found on the surface of galled roots. The length of a root-knot nematode life cycle or generation varies among species but can be as short as two to 6 weeks. Nematodes in cooler regions typically have longer life cycles of up to 10 to 15 weeks in winter. The understanding of the life cycle of root-knot nematodes is important because certain life stages might be easier to target because of their presence in the soil, while other life stages can only be found inside the plant roots. It is possible that nematicidal products only target specific stages of the life cycle.

The options for farmers for nematode control are currently very limited. Control of nematode infections in agriculture can be (partially) achieved by improved sanitation measures, extensive crop rotation with the use of more tolerant or resistant plant varieties, or treatment of the soil with nematicides. However, root knot nematodes multiply on many host plants, and can complete multiple generations per year. This makes it very difficult to expand the crop rotation plan as a control measure. Furthermore, crop rotation will not eliminate infestations because root-knot nematodes can remain in the soil as eggs for at least a year between host crops and most species can feed on a wide range of plants and weeds. Nematode resistance in previously resistant plant varieties is often broken over time and virulent nematode populations can then build up that are not hampered by plant resistance.

Chemical treatment such as usage of nematicides (nematicide treatment of the soil) is also not preferred due to increasing stringent environmental restrictions with respect to the usage of chemicals in disease control. Most of the products with activity against plant parasitic nematodes authorized in Europe (approved nematicidal active substances in accordance with Regulation (EC) No 1107/2009, as listed in Regulation (EU) No 540/2011) are chemicals, including fumigants such as dazomet, metam-Na or -K, and non-fumigants such as fosthiazate and oxamyl. Beside (non)-fumigants, some products based on micro-organisms and plants extracts are also listed, such as the micro-organisms Bacillus firmus, Lysobacter enzymogenes and Purpureocillium lilacinum, as well as garlic extract and the terpene oils eugenol and thymol. However, most of the chemical products have a restricted use due to environmental restrictions, long term damage on the environment, health and mammalian toxicity effects. Fumigants, which are volatile compounds used against broad-spectrum soil organisms present into the soil, are also extremely toxic and can be applied only before sowing or transplanting. The microorganisms' based products usually have only a poor effectivity. In addition, their effects usually greatly depend on the environmental conditions in which the product is applied. Some of the plant extracts are advised to be used in combination with chemical nematicides or require a very high dosage for efficacy.

The European Directive 1107/2009 concerning the sustainable use of pesticides establishes that the use of fumigants and chemical-based nematicides must be reduced with restrictions or prohibitions due to their toxicity to humans and animals and to their impact on the environment. At the same time, the directive establishes that new authorizations have to be more specific, less persistent and less hazardous. For example, the Farm to Fork Strategy of the European Commission discloses that the use of pesticides in agriculture contributes to pollution of soil, water and air. The Commission will take actions to reduce by 50% the use and risk of chemical pesticides by 2030 and to reduce by 50% the use of more hazardous pesticides by 2030. It was also indicated that organic farming is an environmentally-friendly practice that needs to be further developed. The Commission will boost the development of EU organic farming area with the aim to achieve 25% of total farmland under organic farming by 2030. Also, with increasing consumer concerns about the use of chemical plant protection products more and more growers turn to organic or zero-residue production, in which situation the traditional chemical-based nematicide products cannot be used or are heavily restricted.

Considering the above, there is a need in the art for an improved long lasting biological control of parasitic nematodes, more specifically root knot nematodes. In addition there is a need in the art for an effective and efficient control of parasitic nematodes that is of non-chemical, biological origin, providing a sustainable alternative that has no or low toxicity to mammals, reduced impact on the environment, without off-target effects to other organisms.

It is an object of the present invention, amongst other objects, to address the above need in the art. The object of present invention, amongst other objects, is met by the present invention as outlined in the appended claims.

Specifically, the above object, amongst other objects, is met, according to a first aspect, by the present invention by a nematicidal composition for control of nematodes, wherein the composition is comprised of an enzymatic plant based protein hydrolysate. Nematicidal activity refers to the ability to kill and/or paralyze nematodes in any of their stages or to prevent a nematode from developing or growing, and may include nematotoxic or nematostatic activity. The composition may also have an indirect effect by inducing the plant's defence response, which results in the delay of the plant parasitic nematode's life cycle inside the host.

Results show that the composition of present invention comprising the enzymatic plant based hydrolysate was able to greatly reduce the J2 nematode soil population as compared to the nematodes in soil that did not receive the composition. The effect of the enzymatic plant based protein hydrolysate of present invention was shown to be comparable to known chemical nematicides on the market. The enzymatic plant-based protein hydrolysate has an important impact on the survival of the J2 in the soil; it strongly impacts the J2 survival once eggs have been hatched. The composition comprising enzymatic plant based protein hydrolysate showed to be very effective in reducing the nematode population in tomato plants during one and two generations and preventing formation of root knots and galling. Furthermore, and in support of the composition having an indirect effect by inducing nematode resistance in plants, experiments were done on the penetration and development of root-knot nematodes in non-treated and treated tomato plants. Treated plants presented a lower penetration rate of J2 and a delay in the development of nematodes inside the roots compared to non-treated plants.

The composition of present invention is preferably based on the enzymatic hydrolysis of gluten proteins. The gluten hydrolysate is easy to apply to the soil of a plant and is water soluble (in contrast to solid gluten). The composition of the invention can be formulated as a liquid; solid; possibly together with adjuvants, surfactants, co-formulants or other nematicidal compounds. For example, surfactants might enhance the activity of the composition because they will result in an improved spread of the product in the soil. Results show that the enzymatically obtained gluten hydrolysate has a surprisingly more pronounced effect on nematode J2 survival as compared to the acid gluten hydrolysate. The resulting enzymatic gluten hydrolysate contains a mixture of mainly peptides and amino acids. In contrast to an enzymatic hydrolysate, in an acid hydrolysate most of the remaining peptide bonds are destroyed, leaving mainly free amino acids in the mixture. Experiments have shown that the nematicidal effect of the acid hydrolysate is reduced as compared to the enzymatic hydrolysate of present invention.

According to a preferred embodiment, the present invention relates to the nematicidal composition, wherein the enzymatic plant based protein hydrolysate is derived from a plant source that comprises between 20 to 99 wt %, preferably between 50 to 95 wt %, more preferably 75 to 90 wt % plant based protein. The plant based protein refers to protein that is derived from a plant source. The plant source should have a high protein content, to maximize the amount of peptides and amino acids in the hydrolysate. With less than 20% of protein in the plant source, the amount of peptides will be too low in the hydrolysate to have a good nematicidal effect. Also very costly concentration techniques would need to be applied to increase protein content, which would not be economically feasible.

According to a preferred embodiment, the present invention relates to the nematicidal composition, wherein the enzymatic plant based protein hydrolysate is comprised of a peptide fraction comprising (poly) peptides and/or amino acids having a size of between 0.075 to 30 kDa, 0.078 to 25 kDa, 0.08 to 20 kDa, 0.09 to 15 kDa, preferably 0.1 to 10 kDa, 0.15 to 8 kDa, more preferably 0.20 to 5 kDa, even more preferably 0.25 to 5 kDa, most preferably 0.3 to 3 kDa. Peptide fractions are based on size exclusion. Results have shown that the peptide fraction containing the smallest molecules including the <30 kDa peptides, is the fraction providing the nematicidal effect on the nematodes similar to the whole, not fractionated, gluten hydrolysate composition at the lowest dilution tested. This fraction of gluten provides an induction of the plant's immune defence or direct effects on nematodes resulting in reduction of galling incidence of the plant, as observed in tomato plants infected by M. javanica. Composition for plant-parasitic nematode control according to present invention may comprise single or multiple purified fractions of the enzymatic hydrolysate, for example the enzymatic plant based protein hydrolysate comprising the 0.01 to 0.5 kDa and 5 to 10 kDa peptide fractions. Preferably at least the peptide fraction between 0.3 and 5 kDa is included in the nematicidal composition of present invention.

According to another preferred embodiment, the present invention relates to the nematicidal composition, wherein the enzymatic plant based protein hydrolysate comprises a degree of hydrolysis of between 1 to 75%, preferably between 5 to 60%, more preferably between 10 to 50%, most preferably between 15 to 40%. It has been observed that at higher degree of hydrolysis, i.e. >75%, indicating the presence of more single amino acids and less peptides, leads to a decrease in nematicidal activity of the composition. Optimal nematicidal activity has been observed wherein the enzymatic plant based protein hydrolysate comprises a degree of hydrolysis of 15 to 30 wt %.

According to a preferred embodiment, the present invention relates to the nematicidal composition, wherein the plant based protein originates from one or more selected from the group consisting of Poaceae, Fabaceae, Brassicaceae, Asteraceae, Euphorbiaceae, seaweeds, Amaranthaceae, Cannabaceae, Arecaceae or plant proteins of industry by-products of brewery activities, preferably Poaceae and/or Fabaceae. Next to plant based proteins, as alternative the protein source algae may be used, many of which are typically known for high cellular protein content.

According to another preferred embodiment, the present invention relates to the nematicidal composition, wherein the plant based protein is one or more selected from the group consisting of wheat gluten, barley gluten, rye gluten, and oat gluten, soybean or soymeal, guar, preferably wheat gluten.

According to a yet another preferred embodiment, the present invention relates to the nematicidal composition, wherein the nematodes are root-knot nematodes, root-lesion nematodes, cyst nematodes, and/or migratory nematodes. Two life cycle stages of the parasitic root-knot nematodes can especially be targeted in the soil; eggs being laid on the root surface of the plant by the females at maturity stage, and after egg hatching of the second stage juveniles (J2). Experiments show that the J2 nematodes are still able to hatch from their eggs, but after contact with the composition of present invention they quickly die. Therefore, the development of further eggs and nematodes is substantially reduced, as well as galling of the plant roots as a consequence of this.

According to a preferred embodiment, the present invention relates to the nematicidal composition, wherein the nematodes are one or more nematodes selected from the group consisting of Meloidogyne, Heterodera, Globodera, Pratylenchus, Aphelenchoides, Xiphinema, Radopholus, Bursaphelenchus, Rotylenchulus, Nacobbus, Longidorus, Ditylenchus, Trichodorus, Meloidogyne javanica, Meloidogyne arenaria, Meloidogyne incognita, Meloidogyne hapla, Pratylenchus penetrans and Heteredera schachtii, preferably Meloidogyne javanica. Experiments have shown that the composition of present invention, next to M. javanica is also active against M. incognita, P. penetrans and H. schachtii.

According to yet another preferred embodiment, the present invention relates to the nematicidal composition, wherein the composition has nematotoxic and/or nematostatic activity against parasitic nematodes, preferably both nematotoxic and nematostatic activity. The enzymatic plant based protein hydrolysate has a strong, dose dependent nematicidal effect on nematodes in the soil. The nematicidal effect is observed as a toxicity effect that kills the nematodes, in combination with the immobility of the nematodes. The composition may also have an indirect effect by inducing the plant's defence response, which results in the delay of the plant parasitic nematode's life cycle inside the host.

According to another preferred embodiment, the present invention relates to the nematicidal composition, wherein the composition is combined with at least one other compound having nematicidal activity, such as a chemical nematicide or biological nematicide. Examples of suitable chemical nematicide or biological nematicide compounds may include nematicides based on active substances such as dazomet, metam potassium, metam sodium, fluopyram, fosthiazate, oxamyl, abamectin, Bacillus firmus I-1582, Garlic extract, Purpureocillium lilacinum strain 251, and terpenes (thymol and geraniol).

The present invention, according to a second aspect, relates to a method for parasitic nematode control in the soil of a plant by application of a nematicidal composition to the soil of a plant. For example, the composition may be applied to the soil in a dilution of between 0.3 to 25 g/L, preferably 0.6 to 15 g/L, more preferably 1.25 to 10 g/L, most preferably 2.5 to 5 g/L.

According to another preferred embodiment, the present invention relates to the method for parasitic nematode control, wherein the application is done before and/or during the crop cycle of the plant. The composition of present invention is preferably of fully biological, plant-based origin. In contrast to the composition of present invention, fumigants, which are volatile compounds used against broad-spectrum soil organisms present into the soil, are also extremely toxic, also to the plant itself, and can be applied only before sowing or transplanting. The composition of present invention comprising the enzymatic plant protein hydrolysate on the other hand is of vegetal, non-chemical origin and thus a much more sustainable alternative. On top of that, it can also be applied during the crop cycle, which is not the case for fumigants.

According to yet another preferred embodiment, the present invention relates to the method for parasitic nematode control, wherein the composition is applied to the soil at an application frequency selected from the group consisting of once a month, twice a month, four times a month, every two weeks, once a week, and twice a week, preferably every two weeks. Preferably the composition of present invention is applied at a dilution of 5 to 10 g/L, every two weeks.

According to another preferred embodiment, the present invention relates to the method for parasitic nematode control, wherein after application, the nematode is controlled for at least two nematode generations, preferably at least three nematode generations, more preferably at least four nematode generations.

According to a preferred embodiment, the present invention relates to the method for parasitic nematode control, wherein at least 50%, preferably at least 75%, more preferably at least 90% of the nematodes are immobilized and/or killed, preferably killed.

According to yet another preferred embodiment, the present invention relates to the method for parasitic nematode control, wherein the application of the nematicidal composition is done by irrigation, soil drenching, via a drip irrigation system on the soil or solid application via granules, coating and dipping.

The present invention, according to a third aspect, relates to the use of a nematicidal composition of present invention for the control of parasitic nematodes in the soil of a plant.

The present invention will be further detailed in the following examples and figures wherein:

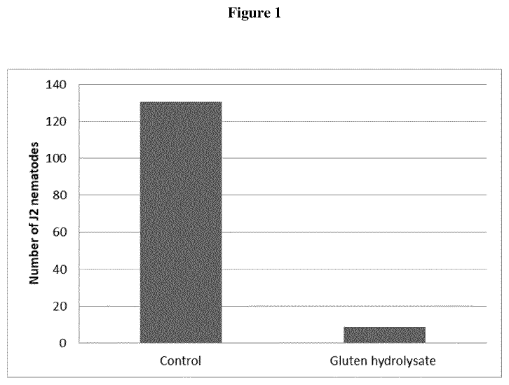

FIG. 1: shows the effect of the enzymatic gluten hydrolysate of present invention on J2 M. javanica. After one week of incubation with the nematodes and the composition of present invention the living J2 were recovered and counted. The control group did not receive any nematicidal treatment.

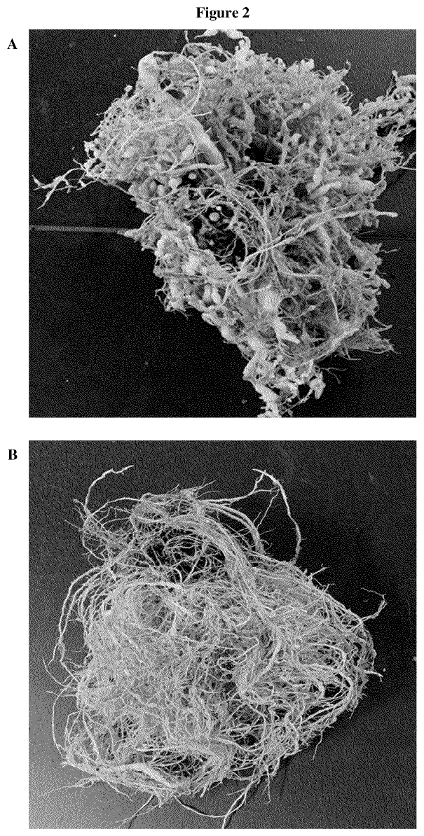

FIG. 2: A) shows roots of a tomato plant of the control group exposed to J2 M. javanica (not receiving the enzymatic gluten hydrolysate of present invention) having a gall index (GI)-score of 4.35 and having severe disease symptoms showing massive galling symptoms. B) shows roots of a tomato plant exposed to J2 M. javanica and receiving the enzymatic gluten hydrolysate (10 g/L, per week) of present invention having a GI-score of 1.2 and having very little disease symptoms with strongly reduced galling symptoms.

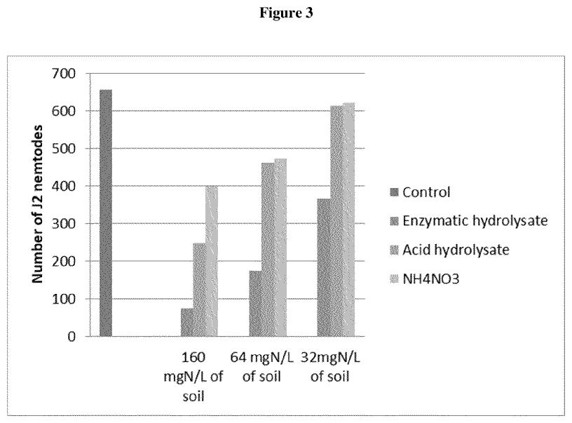

FIG. 3: shows the effect of enzymatic wheat gluten hydrolysate on nematode survival compared to acid wheat gluten hydrolysate. Furthermore, the effect of nitrate fertilization (nitrogen effect) on nematode survival that is often observed in practice was also tested; the activity of the gluten hydrolysates and the ammonium nitrate fertilizer were compared at various nitrogen concentrations (160 mg N/L, 64 mg N/L and 32 mg N/L). A dose-dependent effect is observed wherein the enzymatically obtained wheat gluten hydrolysate has a more pronounced effect on nematode J2 survival as compared to the acid wheat gluten hydrolysate. This was observed in all N concentrations.

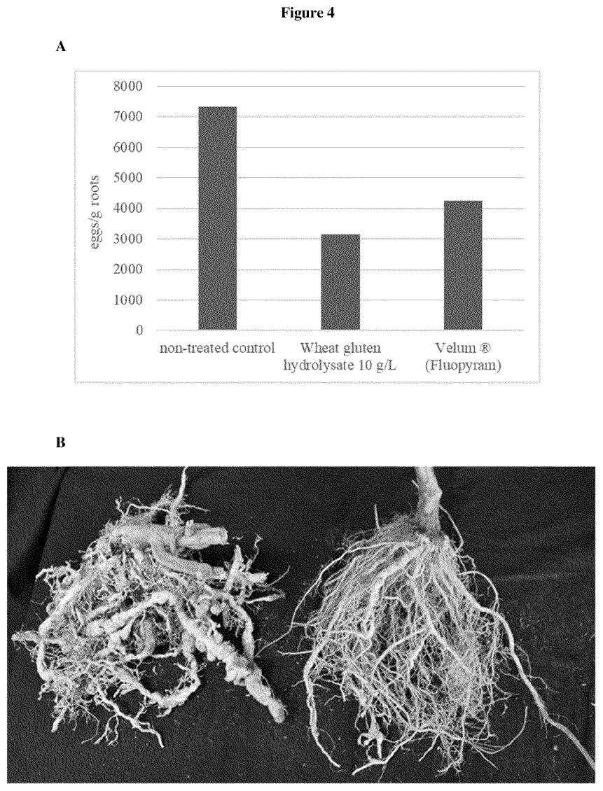

FIG. 4: FIG. 4A shows the number of eggs/g (vertical axis) of tomato plant roots treated with the enzymatic wheat gluten hydrolysate (every two weeks) of present invention and tomato plant roots treated with the commercial product Velum®. 10 g/L of enzymatic wheat gluten hydrolysate provided 57% and Velum a 41% reduction, as compared to the non-treated control. FIG. 4B shows the tomato root non-treated control (left) and tomato root of a plant treated with 10 g/L of wheat gluten hydrolysate (right) every two weeks.

### EXAMPLES

Effect of Wheat Gluten Hydrolysate on J2 M. javanica

The effect of the enzymatic wheat gluten hydrolysate on the second-stage juveniles (J2) of M. javanica was determined in a preplanting experiment. Experiments were performed using wheat gluten hydrolysate from wheat gluten comprising ˜ 81% protein, followed by a protease enzyme incubation for 48 h and subsequent deactivation step by heating, providing a degree of hydrolysis between 15 and 30%. Sterilized soil was placed into 0.5 L pots and then placed on a glasshouse bench. Soil was inoculated with seven M. javanica second stage juveniles (J2) per mL of soil (3500 J2/pot). One day after nematode inoculation the wheat gluten hydrolysate was applied to the soil at 25 g/L. Then, pots were covered and kept on the glasshouse bench (26° C.). After one week the living J2 were recovered and counted. In the control group (not receiving the wheat gluten hydrolysate), 131 (±29) J2 per 100 mL of soil were counted. In the pots that received wheat gluten hydrolysate only 9 (±8) J2 per 100 mL of soil were counted. The wheat gluten hydrolysate was able to greatly reduce the J2 soil population compared to the Control (see FIG. 1).

Dose Dependent Effect of Wheat Gluten Hydrolysate on J2 M. javanica

The effect of different doses of the wheat gluten hydrolysate was determined in another preplanting experiment. 100 mL pots filled with sterilized soil were inoculated with M. javanica at eighteen J2 per mL of soil (1800 J2/pot). One day after the nematode inoculation, different doses of the enzymatic wheat gluten hydrolysate were applied (10 g/L, 5 g/L, 2.5 g/L and 1.25 g/L). Untreated soil (no wheat gluten hydrolysate) served as control. Then, pots were covered and kept on a laboratory bench (23° C.). After one week the living J2 were recovered and counted. Table 1 shows the effect of different doses of the wheat gluten hydrolysate against J2 M. javanica after one week in covered pots filled with sterilized soil.

TABLE 1

| Treatment | Live J2 per 100 mL soil |
|---|---|
| Control | 131 ± 10 |

| | | |
|---|---|---|
| 10 | g/L | 8 ± 5 |
| 5 | g/L | 15 ± 5 |
| 2.5 | g/L | 35 ± 8 |
| 1.25 | g/L | 73 ± 10 |

This experiment confirmed that wheat gluten hydrolysate has an important impact on the survival of the J2 in the soil, and this effect is dose-dependent.
Effect of the Wheat Gluten Hydrolysate on the Egg Hatching of M. javanica

An experiment was performed to evaluate the effect of different doses (10 g/L, 5 g/L, 2.5 g/L, 1.25 g/L, 0.626 g/L and 0.3125 g/L) of the enzymatic wheat gluten hydrolysate against M. javanica eggs. The product was mixed with fresh nematode eggs and kept together during a week at 25° C. in the dark. The percentage of egg hatching and the percentage of the mortality of the J2 after hatching were determined. Table 2 shows the effect of the wheat gluten hydrolysate on the egg hatching of M. javanica one week after the product application and of mortality of the hatched J2. The wheat gluten hydrolysate does not seem to inhibit egg hatching, however it strongly impacts the J2 survival once hatched, which again confirms our earlier results.

TABLE 2

| Treatment | % egg hatching | % J2 mortality after hatching |
|---|---|---|
| Control | 15 | 8.6 |

| | | | |
|---|---|---|---|
| 10 | g/L | 14.5 | 100 |
| 5 | g/L | 13.4 | 100 |
| 2.5 | g/L | 14.9 | 100 |
| 1.25 | g/L | 12.3 | 100 |
| 0.626 | g/L | 13.5 | 65.1 |
| 0.3125 | g/L | 13.2 | 26 |

Nematicidal and Nematostatic Effects of Wheat Gluten Hydrolysate on M. javanica

The nematicidal (toxicity on J2 M. javanica) and nematostatic (immobility of J2 M. javanica) effects at different doses (10 g/L, 5 g/L, 2.5 g/L, 1.25 g/L, 0.626 g/L and 0.3125 g/L) of the enzymatic wheat gluten hydrolysate on M. javanica J2 was evaluated. The doses were mixed with J2 and kept together during 4 and 7 days at 25° C. in the dark. The percentage of the immobilized and dead J2 was determined. Table 3 shows the nematicidal (% mortality J2) and nematostatic (% immobilized J2) effect of the wheat gluten hydrolysate on M. javanica.

TABLE 3

| | | | | After 7 days | |
|---|---|---|---|---|---|
| | | After 4 days | | % | % |
| | | % | % | immobilized | mortality |
| Treatment | | immobilized J2 | mortality J2 | J2 | J2 |
| Control | | 10.3 | 5.3 | 4.4 | 8 |
| 10 | g/L | 100 | 100 | 100 | 100 |
| 5 | g/L | 100 | 76.5 | 100 | 100 |
| 2.5 | g/L | 100 | 81.8 | 100 | 100 |
| 1.25 | g/L | 100 | 21.1 | 100 | 100 |
| 0.626 | g/L | 100 | 20 | 100 | 58.3 |
| 0.3125 | g/L | 84.2 | 10.8 | 85.0 | 4.5 |

The results confirm the nematicidal effect of the wheat gluten hydrolysate and how increasing the contact time can lead to an additional increase in the mortality rate, even at lower concentrations.

### The Effect of the Wheat Gluten Hydrolysate on Plant-Nematode Interaction in a Greenhouse.

Having determined the extend and repeatable nematicidal effect of wheat gluten hydrolysate on J2 M. javanica in soil, greenhouse experiments with tomato plants were performed. The effect of the wheat gluten hydrolysate (10 g/L) was studied in a plant-nematode interaction experiment in a greenhouse. Tomato plants were transplanted into 1 L and 3 L pots with sterilized soil, to determine the effect after the completion of one and two nematode generations, respectively. The 1 L pots were inoculated with 1000 J2 M. javanica and in 3 L pots with 3000 J2 M. javanica. The composition of the present invention was applied on the soil by drenching every week. The first application was realized after nematode inoculation. The number of nematode eggs per gram of root, and number of J2 nematodes per 100 mL of soil were evaluated after one and two generations. Table 4 summarized the results.

TABLE 4

| | After 1 generation | | After 2 generations | |
|---|---|---|---|---|
| | # Eggs/gram | # J2/100 mL | # Eggs/gram | # J2/100 mL |
| Treatment | root | soil | root | soil |
| Control | 4989 ± 774 | 586 ± 80 | 59317 ± 4246 | 2304 ± 422 |
| 10 g/L | 42 ± 12 | 0 | 4709 ± 1340 | 16 ± 8 |

Furthermore, the disease severity (galling index, GI-score) was determined at the end of the second generation, from 0 (healthy plants) to 10 (dead plants) as previously described by Zeck, W. M. et al, 1971, “A rating scheme for field evaluation of root-knot nematode infestations.”, Pflanz. Nachricht. Bayer. 24, 141-144. A GI score above 5 relates to severe galling symptoms that are unacceptable in agriculture. The control plants scored a galling index (GI) of 4.35 and the plants treated with the composition of present invention scored a galling index of 1.2.

The results show the effectiveness of wheat gluten hydrolysate in reducing the nematode population in tomato plants in a greenhouse during one and two generations. The effect is long lasting, preventing J2 survival in the soil and preventing formation of galls.

### The Effect of the Wheat Gluten Hydrolysate on Other Plant Parasitic Nematodes

An experiment was performed to evaluate the effect of different doses (5 g/L, 2.5 g/L, 1.25 g/L, 0.626 g/L and 0.3125 g/L) of the enzymatic wheat gluten hydrolysate against two root-knot nematodes species M. javanica and M. incognita, a migratory plant parasitic Pratylenchus penetrans and a cyst nematode Heterodera schachtii. The product was mixed with fresh nematodes (juveniles and adults) and kept together for 48 h at 25° C. in the dark. The percentage of nematode mortality was determined. Table 5 shows the effect of the enzymatic wheat gluten hydrolysate on the four different nematodes after the product application.

TABLE 5

| | | % of nematode mortality | | | |
|---|---|---|---|---|---|
| | | Meloidogyne | Meloidogyne | Pratylenchus | Heterodera |
| Treatments | | javanica | incognita | penetrans | schachtii |
| Control (water) | | 2.6 | 6.53 | 3.68 | 5.82 |
| 5 | g/L | 100.00 | 100.00 | 95.00 | 96.64 |
| 2.5 | g/L | 100.00 | 100.00 | 91.96 | 94.02 |
| 1.25 | g/L | 94.44 | 94.62 | 85.71 | 85.34 |
| 0.626 | g/L | 81.52 | 93.68 | 81.89 | 76.40 |
| 0.3125 | g/L | 46.34 | 25.58 | 12.39 | 29.91 |

The wheat gluten hydrolysate had a nematicidal effect on all plant parasitic nematodes tested.

The Effect of Wheat Gluten Hydrolysate at Different Application Frequencies on M. javanica

The effect of different doses (10 g/L and 5 g/L) of the wheat gluten hydrolysate were tested with different application frequencies (one (1 w), two (2 w) and three weeks (3 w)) by drenching sterilized soil in a greenhouse experiment. Tomato plants were inoculated one week after transplanting with 1000 J2 M. javanica in 1 L pots to determine the effect after completion of one nematode generation The treatments began after the nematode inoculation. The number of nematode eggs per gram of root, and number of J2 nematodes per 100 mL of soil were evaluated. Table 6 summarizes the results.

TABLE 6

| Treatment | # Eggs/gram root | # J2/100 mL soil |
|---|---|---|
| Control | 21301 ± 2274 | 665 ± 198 |

| | | | |
|---|---|---|---|
| 10 | g/L 1 w | 522 ± 326 | 1 ± 1 |
| 10 | g/L 2 w | 959 ± 323 | 2 ± 1 |
| 10 | g/L 3 w | 1797 ± 559 | 5 ± 2 |
| 5 | g/L, 1 w | 4298 ± 1115 | 12 ± 4 |
| 5 | g/L, 2 w | 8059 ± 1869 | 56 ± 13 |
| 5 | g/L, 3 w | 13376 ± 2836 | 88 ± 27 |

The results show that the reduction of the nematode population by the wheat gluten hydrolysate is dose and frequency dependent in a greenhouse.

### Enzymatic Wheat Gluten Hydrolysate Compared to Acid Wheat Gluten Hydrolysate on J2 Nematode Survival

In this experiment the effect on J2 survival of the wheat gluten hydrolysate that was obtained via enzymatic hydrolysis was compared to wheat gluten hydrolysate obtained via acid hydrolysis. Furthermore, a limited effect of nitrate fertilization on nematode survival is often observed in practice. To check for this nitrogen effect, we included the mineral fertilizer ammonium nitrate. The wheat gluten hydrolysates and ammonium nitrate were tested at various nitrogen concentrations (160 mgN/L, 64 mgN/L and 32 mgN/L).

100 mL pots filled with sterilized soil were inoculated with M. javanica at 18 J2 per mL of soil (1800 J2 per pot). One day after the nematode inoculation, the treatments were applied. Then, pots were covered and kept on a laboratory bench (23° C.). After one week the living J2 were recovered and counted. The results are summarized in FIG. 3.

A dose-dependent effect is observed wherein the enzymatically obtained wheat glute hydrolysate has a more pronounced effect on nematode J2 survival as compared to the acid wheat gluten hydrolysate. This was observed in all the tested N concentrations. The enzymatic hydrolysate of wheat gluten (according to present invention), comprises a mixture of mainly peptides and amino acids. In the acid hydrolysate most of the remaining peptide bonds are destroyed, leaving mainly free amino acids in the mixture. The nematicidal effect of the acid hydrolysate is reduced as compared to the enzymatic hydrolysate of present invention. The nematicidal effect of the acid hydrolysate is similar to the effect of the ammonium nitrate, which indicates that the nematicidal effect of the enzymatic hydrolysate of wheat gluten is (next to the nitrogen effect) due to intact peptides present in the hydrolysate, which are absent in the acid hydrolysate.

Effect of Hydrolysate Fractions of Wheat Gluten Hydrolysate on M. javanica

Next, in order to further understand the mode of action of the enzymatic wheat gluten hydrolysate on the nematodes, and especially the role of the peptide fraction, the wheat gluten hydrolysate was fractionized by membrane filtration. The effect of four size fractions of the wheat gluten hydrolysate (fraction R1: >30 kDa, fraction R2: >10 kDa, fraction R3: >3 kDa, fraction P3: <3 kDa) was evaluated in an in vitro experiment against M. javanica J2. The non-fractionated wheat gluten hydrolysate was used as a control. Each fraction was mixed with J2 and kept for 48 hours at 25° C. in the dark. Afterwards, the percentage of dead J2 was determined. The results are summarized in Table 7 and indicate that fraction P3 (<3 kDa), the fraction containing the smallest molecules including the peptides, provides the most optimal nematicidal effect on the nematodes similar to the wheat gluten hydrolysate control at the lowest dilution (0.3125 g/L).

TABLE 7

| | | % of dead J2 per fraction | | | | |
|---|---|---|---|---|---|---|
| Dilution | | >30 kDa | >10 kDa | >3 kDa | <3 kDa | Control |
| 5 | g/L | 100 | 100 | 100 | 100 | 100 |
| 2.5 | g/L | 100 | 100 | 100 | 100 | 100 |
| 1.25 | g/L | 100 | 100 | 100 | 100 | 100 |
| 0.626 | g/L | 61.3 | 60.1 | 100 | 100 | 100 |
| 0.3125 | g/L | 1.1 | 0.3 | 21.8 | 88.7 | 94.7 |

In a second experiment (Table 8), the fraction size between 5 and 0.3 kDa had the best nematicidal effect among the other tested peptide fractions.

TABLE 8

| | | % of dead J2 per fraction | | | | |
|---|---|---|---|---|---|---|
| Dilution | | >25 kDa | >5 kDa | >0.3 kDa | <0.3 kDa | Control |
| 5 | g/L | 98 | 98 | 99 | | 98 |
| 2.5 | g/L | 99 | 98 | 98 | 98 | 96 |
| 1.25 | g/L | 95 | 97 | 99 | 98 | 89 |
| 0.626 | g/L | 89 | 97 | 97 | 23 | 92 |
| 0.3125 | g/L | 29 | 41 | 97 | 4 | 87 |

The combined results of the experiments indicate that the most active nematicidal fraction size is between 3 to 0.3 kDa.

Effect of Hydrolysate Fractions of Wheat Gluten Hydrolysate on M. javanica In Vivo

After the in vitro results with the peptides fractions and M. javanica second stage juveniles, these fractions sizes were also tested in vivo, in a greenhouse on tomato plants. The effect of the non-fractionated enzymatic wheat gluten hydrolysate (10 g/L) and the enzymatic wheat gluten hydrolysate fractions of different peptide sizes were studied in a plant-nematode interaction experiment. Tomato plants were transplanted into 2 L pots with sterilized soil, to determine the effect after the completion of one generation. The 2 L pots were inoculated with 2000 J2 M. javanica. The product was applied on the soil by drenching every two weeks. The percentages of reduction on the eggs per gram of root (compared to the non-treated control) after one generation can be observed in table 9. The results show the effectiveness of the enzymatic wheat gluten hydrolysate and all the other fractions sizes in reducing the nematode population in tomato plants, and especially the fraction 5-0.3 kDa.

TABLE 9

| Treatments; fraction size | % of reduction of total eggs* |
|---|---|
| Fraction size > 25 kDa | 87.44 |
| Fraction size > 5 kDa | 86.17 |
| Fraction size > 0.3 kDa | 97.91 |
| Fraction size < 0.3 kDa | 86.59 |

*Level of Infection in the control (non-treated plants) = 38750 eggs/plant

Effect of Enzymatic Plant Protein Hydrolysates of Various Plant Protein Sources on M. javanica In Vitro

Experiments were performed to evaluate the effect of different doses (5 g/L, 2.5 g/L, 1.25 g/L, 0.626 g/L and 0.3125 g/L) of the enzymatic wheat gluten hydrolysate and other enzymatic plant protein hydrolysates (soymeal and guar enzymatic hydrolysates) on M. javanica. The products were mixed with nematodes and kept together for 48 h at 25° C. in the dark. The percentage of nematode mortality was determined. Table 10 shows the effect of the wheat gluten and guar and soymeal hydrolysates on M. javanica J2 after application.

TABLE 10

| | | % of J2 mortality | | |
|---|---|---|---|---|
| | | Wheat gluten | | |
| Treatments | | hydrolysate | Soymeal hydrolysate | Guar hydrolysate |
| 5 | g/L | 98.36 | 97.67 | 99.13 |
| 2.5 | g/L | 96.00 | 96.83 | 97.71 |
| 1.25 | g/L | 88.89 | 97.06 | 95.21 |
| 0.626 | g/L | 92.41 | 96.40 | 94.31 |
| 0.3125 | g/L | 86.58 | 91.89 | 93.57 |
| 0.15625 | g/L | 8.84 | 84.89 | 5.59 |

The results demonstrate that plant protein enzymatic hydrolysates from other plant sources besides wheat gluten can also have a nematicidal effect.

Study on the Penetration and Development of M. javanica in Treated and Non-Treated Plants

The penetration, development and reproduction of the root-knot nematode, Meloidogyne javanica, in tomato plants treated with wheat gluten hydrolysate (10 g/L) and non-treated, were studied and compared. The plants were inoculated with a nematode suspension of 3 J2 per gram of soil and then uprooted at 5 and 20 DAI (days after inoculation) and at the end of the first generation. At each sampling date, the whole root systems were carefully removed, washed, and stained in NaOCI-acid fuchsin-glycerin according to the method described by Byrd et al., 1983. Penetration of M. javanica at 5 DAI was determined by counting the J2 in the stained roots using a stereomicroscope. At 20 DAI, the different nematode developmental stages (J2 vermiform, J3 and J4, and adult female and male) were counted using a stereomicroscope. In the end of the first generation, the numbers of egg-laying females and galls per plant were considered.

Total number of nematodes in non-treated and treated tomato roots with wheat gluten hydrolysate (10 g/L) after 5 and 20 days after inoculation and in the end of the first generation are summarized in table 11; the comparative results show a reduction in early penetration and later delay in the development of the nematode in the treated plants compared to the non-treated control.

TABLE 11

| | | J2 | J3 and | Egg-laying | Total |
|---|---|---|---|---|---|
| Period | Treatments | stage | J4 stage | females | galls |
| 5 DAI | non-treated control | 102 | — | — | — |
| | wheat gluten | 49 | — | — | — |
| | hydrolysate (10 g/L) | | | | |
| 20 DAI | non-treated control | 12 | 350 | — | 105 |
| | wheat gluten | 22 | 115 | — | 72 |
| | hydrolysate (10 g/L) | | | | |
| End of 1st | non-treated control | — | — | 119 | 169 |
| generation | wheat gluten | — | — | 12 | 74 |
| | hydrolysate (10 g/L) | | | | |

This result suggests a direct nematicidal/nematostatic or even repellent effect of the enzymatic plant protein hydrolysate, but also an indirect effect: induction of resistance and delaying in the further completion of the nematode life cycle once they have entered the roots.

### Efficacy of Wheat Gluten Hydrolysate Versus Commercial Nematicide

To determine the efficacy of the wheat gluten hydrolysate, an experiment was conducted in a plastic greenhouse heavily infested with root-knot nematode Meloidogyne incognita (172 to 553 juveniles/250 cc soil). The wheat gluten was tested in two concentrations (10 g/L and 5 g/L) and a commercial nematicide (Velum®, active substance: fluopyram) applied according to the manufacturer's instructions was included as chemical control. The products were applied on the soil by drenching every two weeks.

The wheat gluten treatments reduced the nematode reproduction after two generations (10 g/L 57% reduction and Velum 46% reduction, as compared to the non-treated control) similar, even slightly better, as compared to the commercial product (FIGS. 4A and B).

1. A nematicidal composition for control of nematodes, wherein the composition comprises an enzymatic plant based protein hydrolysate.

2. The nematicidal composition according to claim 1, wherein the enzymatic plant based protein hydrolysate is derived from a plant source that comprises between 20 to 99 wt %, preferably between 50 to 95 wt %, more preferably 75 to 90 wt % plant based protein.

3. The nematicidal composition according to claim 1, wherein the enzymatic plant based protein hydrolysate is comprised of a peptide fraction comprising peptides and/or amino acids having a size of between 0.075 to 30 kDa.

4. The nematicidal composition according to claim 1, wherein the enzymatic plant based protein hydrolysate comprises a degree of hydrolysis of between 1 to 75%.

5. The nematicidal composition according to claim 1, wherein the plant based protein originates from one or more selected from the group consisting of Poaceae, Fabaceae, Brassicaceae, Asteraceae, Euphorbiaceae, seaweeds, Amaranthaceae, Cannabaceae, Arecaceae, preferably Poaceae and/or Fabaceae.

6. The nematicidal composition according to claim 1, wherein the plant based protein is one or more selected from the group consisting of wheat gluten, barley gluten, rye gluten, and oat gluten, soybean or soymeal, guar.

7. The nematicidal composition according to claim 1, wherein the nematodes are root-knot nematodes, root-lesion nematodes, cyst nematodes, and/or migratory nematodes.

8. The nematicidal composition according to claim 1, wherein the nematodes are one or more nematodes selected from the group consisting of Meloidogyne, Heterodera, Globodera, Pratylenchus, Aphelenchoides, Xiphinema, Radopholus, Bursaphelenchus, Rotylenchulus, Nacobbus, Longidorus, Ditylenchus, Trichodorus, M. javanica, M. arenaria, M. incognita, M. hapla, P. penetrans and H. schachtii.

9. The nematicidal composition according to claim 1, wherein the composition has nematotoxic and/or nematostatic activity against parasitic nematodes, preferably both nemtotoxic and nematostatic activity.

10. The nematicidal composition according to claim 1, wherein the nematodes comprise one or more selected from the group consisting of nematode eggs or motile nematode stages, second-stage (J2) juveniles root-knot or cyst nematodes, and/or motile life stages of migratory nematodes

11. The nematicidal composition according to claim 1, wherein the composition is combined with at least one other compound having nematicidal activity.

12. A method for parasitic nematode control in the soil of a plant by application of the nematicidal composition according to claim 1, to the soil of a plant.

13. The method for parasitic nematode control according to claim 12, wherein the application is done before and/or during the crop cycle of the plant.

14. The method for parasitic nematode control according to claim 12, wherein the composition is applied to the soil at an application frequency selected from the group consisting of once a month, twice a month, four times a month, every two weeks, once a week, and twice a week, preferably every two weeks.

15. The method for parasitic nematode control according to claim 12, wherein after application, the nematode is controlled for at least two nematode generations.

16. The method for parasitic nematode control according to claim 12, wherein at least 50 of the nematodes are immobilized and/or killed.

17. The method for parasitic nematode control according to claim 12, wherein the application of the nematicidal composition is done by irrigation, soil drenching, via a drip irrigation system on the soil or solid application via granules, coating and dipping.

18. A use of the nematicidal composition according to claim 1, for the control of parasitic nematodes in the soil of a plant.
